(19) United States
(12) Patent Application Publication
(10) Pub. No.: US 2016/0292751 A1
(43) Pub. Date: Oct. 6, 2016

(54) PRODUCT VALUATION SYSTEM AND METHOD

(71) Applicant: Richard Lee Hartman, Warren, OH (US)

(72) Inventor: Richard Lee Hartman, Warren, OH (US)

(73) Assignee: CARRIER SERVICES GROUP, INC., Vienna, OH (US)

(21) Appl. No.: 14/673,939

(22) Filed: Mar. 31, 2015

(51) Int. Cl. G06Q 30/02

(52) U.S. Cl. CPC G06Q 30/0278; G06Q 30/0283

(57) ABSTRACT

The invention may generally related to systems and methods for valuing used electronic, computing, and/or telecommunications equipment. Some embodiments may enable valuation to approach an efficient market value based on historical sales data and forward projection methods, and/or may also provide improved calculation efficiency.

### I. BACKGROUND OF THE INVENTION

A. Field of Invention

Some embodiments of the present invention may generally relate to the field of valuing electronics, computing, and/or telecommunications equipment.

B. Description of the Related Art

Computing devices are ubiquitous in the modern world, and many industries, especially telecommunications companies, rely on very large numbers of high tech devices which must be serviced, upgraded, and replaced on a regular basis. Therefore, a large number of such devices are continuously entering the secondary market. Until now it was impossible to make informed decisions regarding how best to dispose of used electronics. For instance, one could not know for sure whether it was best to refurbish, resell, or scrap a given item. This was largely due to difficulties in ascertaining an accurate valuation.

According to the prior art, a typical valuation would entail calling one or more companies and asking how much they would pay for a given lot of used devices. The content and condition of the lot was generally unreliable in part because device configurations may change over time due to upgrades, parts having been scavenged, and the age and condition of the individual devices not being ascertainable. In addition to these deficiencies of knowledge regarding the devices themselves, the transaction inherently involved a small number of offers, so it was difficult or even impossible to know whether any given offer was competitive. In fact, each transaction occurred without knowledge of other similar transactions, so it was inherently based on one's own experience. Not surprisingly, under these conditions similar transactions may result in very different sale prices.

Some embodiments of the present invention may provide one or more benefits or advantages over the prior art.

### II. SUMMARY OF THE INVENTION

Some embodiments may relate to a product valuation method comprising the steps of: providing a database of historical sales, forecast sales, and scrap sales comprising at least a buyer identity field, an item identifier field, a quantity field for containing a quantity of an item bought in a historical sale, a price field for containing a price paid for an item in a historical sale, a date field for containing the date of a historical sale, a forecast sale price field in association with a date field to which the forecast sale price field relates, and a scrap sale price field in association with a date field to which the scrap sale price field relates; reading into memory a list of at least one item to be valued wherein each item of the list is associated with an item identifier; comparing the item identifier of each item of the list to the database; retrieving historical sales data relating to each item of the list from the database according to the item identifier; obtaining a historical sale value for each item of the list by multiplying a quantity of each item read into memory bearing the same item identifier by a historical sale price for each item having the same item identifier; obtaining a historical sale total value by summing the historical sale values for each item; retrieving forecast sale data for each item of the list from the database according to the item identifier; obtaining a forecast sale value for each item of the list by multiplying a quantity of each item read into memory bearing the same item identifier by a forecast sale price for each item having the same item identifier; obtaining a forecast sale total value by summing the forecast sale values for each item; retrieving scrap sale data for each item of the list from the database according to the item identifier; obtaining a scrap sale value for each item of the list by multiplying a quantity of each item read into memory bearing the same item identifier by a scrap sale price for each item having the same item identifier; obtaining a scrap sale total value by summing the scrap sale values for each item; generating a report including the historical sale total value, the forecast sale total value, and the scrap sale total value.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic representation of a method according to one embodiment of the invention;

FIG. 2 is a drawing of part of an example inventory sheet according to an embodiment;

FIG. 3 is a drawing of part of a historical sales record of an embodiment;

FIG. 4 is a drawing of a sample historical sales report for a single item;

FIG. 5 is a drawing of a sample linear regression plot of historical sales data;

FIG. 6 is a drawing of a sample forecast sales record of an embodiment;

FIG. 7 is a drawing of a sample report according to an embodiment; and

FIG. 8 is a schematic drawing of a computer implemented process according to one embodiment of the invention.

### IV. DETAILED DESCRIPTION OF THE INVENTION

In general, a product valuation system and/or method embodiment of the present invention may operate by accepting an inventory data file such as a spreadsheet, comparing the inventory contained in the data file to a database of historical sales for the same kind(s) of product(s), and calculating a value for the inventory by predicting future sale price based on the database of historical sales. Furthermore, values may be calculated according to mode of disposal. More specifically, a user may be provided with a report predicting the value of the inventory if it were resold, resold to a particular buyer, or sold for scrap, among various other value types which will be described in more detail herein.

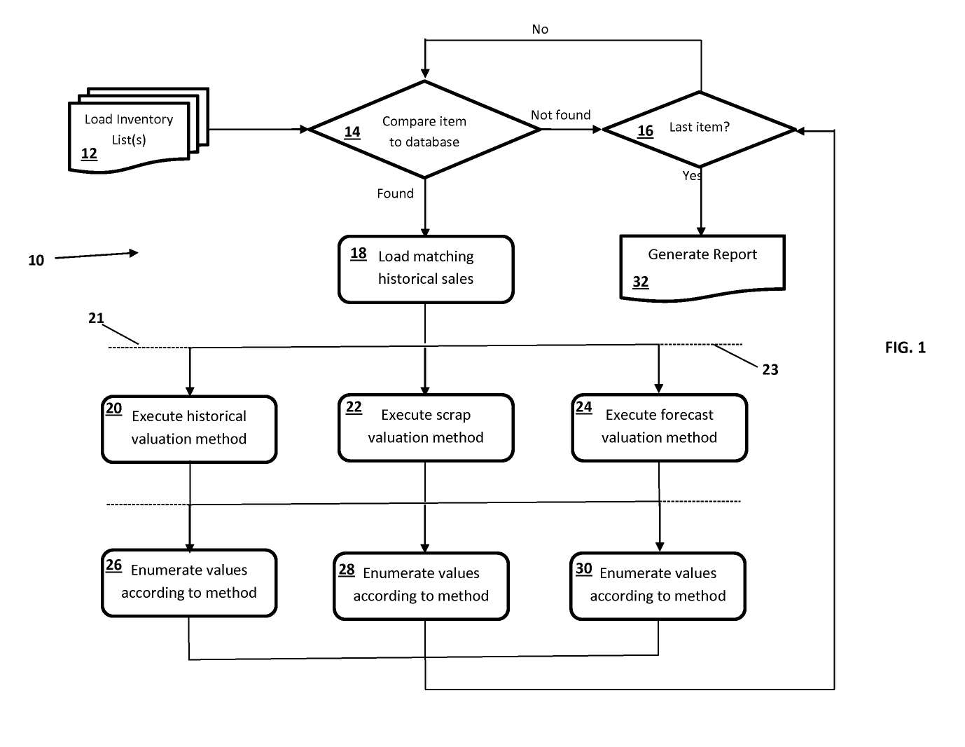

Referring now to the drawings wherein the showings are for purposes of illustrating embodiments of the invention only and not for purposes of limiting the same, FIG. 1 is an overall schematic view of a method 10 according to an embodiment of the invention. The method begins by loading an inventory list 12 into the memory of a suitably programmed computer. A first item in the inventory list is then compared 14 to a database of historical sales records to determine whether similar sales have been made. If one or more matching historical sales are found, then the matching sales data is loaded 18 into memory. Alternatively, if no matching sale is found then the method checks whether the list contains another item 16, and if so it loops back through the previous steps as shown in FIG. 1.

Having loaded matching historical sales in step 18, the item is then valued according to each of a plurality of valuation methods 20, 22, and 24. Dotted lines 21 and 23 are intended to indicate that other valuation methods may also be a part of method 10. The results of each valuation method 20, 22, 24 are enumerated in respective results lists 26, 28, and 30. The method 10 then loops back to step 16 and checks whether there is another inventory item to value. If so then the method continues to loop through the valuation 20, 22, 24 and enumeration 26, 28, 30 steps until the entire inventory list 12 is exhausted. After the last item in the inventory list 12 is valued and enumerated the method 10 generates a report 32. Though not shown, the report 32 shows the total value of the inventory list 12 according to each valuation method. More particularly, the enumerated lists of values 26, 28, and 30 are summed and their respective sums appear in the report labeled according to the valuation method by which they were determined. Accordingly, a seller can use the report to determine how it wishes to dispose of its list of inventory, i.e. whether it would be more economically beneficial to resell the goods on the secondary market, or to sell them for scrap.

In a related embodiment, a variation of method 10 may assign individual inventory items to be resold on the secondary market, sold for scrap, or otherwise assign the items individually according to the disposal method that brings the greatest economic reward. Therefore, according to this variation, some inventory items may be earmarked for scrap while others may be resold. This is in contrast to the method explicitly illustrated in FIG. 1 wherein the entire inventory list is valued as a whole according to each valuation method.

In another variation of the method illustrated in FIG. 1, the forecast valuation method of step 24 may be omitted from reports generated for the benefit of sellers in step 32. Rather, this valuation method may be reserved for a buyer and/or intermediate broker to whom the seller is offloading its goods. Accordingly, the buyer/broker may have the benefit of several different valuation methods to determine how much it is willing to pay the seller in light of current and forecast resale values, and its scrap value.

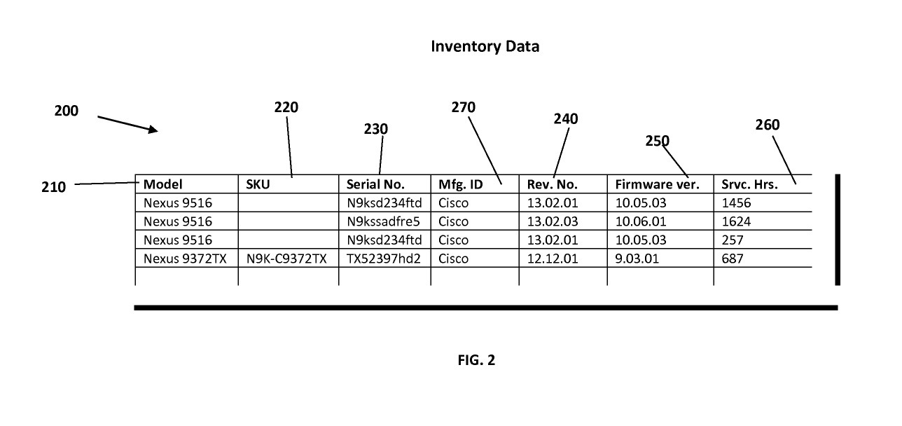

FIG. 2 illustrates an example inventory table 200 corresponding to step 12 of method 10. Embodiments may include inventory tables having data fields differing from those illustrated here. However, typical fields would include a data identifying an inventory item such as a model number 210, SKU 220, serial number 230, Common Language Equipment Identification (CLEI) code, revision number 240, firmware version 250, etc. Embodiments may also include fields for containing the number of service hours 260 pertaining to an inventory item and/or its age, and/or a code indicating the original equipment manufacturer (OEM) 270. Again, these are merely non-limiting examples of the kind of data that one may include in an inventory table of an embodiment. Notwithstanding, the data should be sufficient to look up similar historical sales from a database of an embodiment.

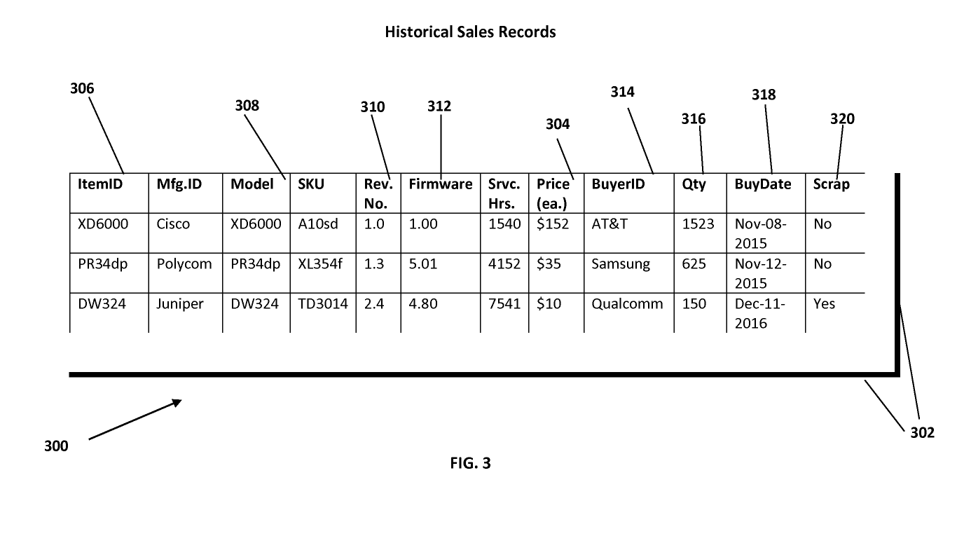

FIG. 3 is a drawing of an exemplary portion of an historical sales database 300 according to some embodiments of the invention. Jagged lines 302 are intended to indicate that the database 300 extends beyond the rows and column explicitly illustrated here, and is not limited to the illustrated data fields.

As shown, database 300 may include historical sale prices 304 for one or more electronic, computing, and/or telecommunications devices. The devices may be identified by an item identifier 306 which may be any indicium capable of grouping products that are similar in kind and thus have comparable values. In the illustrated embodiment, the model number 308 also serves as the item identifier 306 (i.e. “ItemID”). However, other acceptable indicia may serve as an item identifier 306 including, without limitation, part numbers, Common Language Equipment Identification (CLEI) codes, SKU numbers, or revision numbers.

As used in the foregoing context, the term “comparable values” refers to a group of products for which a monetary value can be reasonably estimated according to a common set of rules and parameters. For instance, a given make and model of a device may have, without limitation, a known manufacturer suggested retail price (MSRP), a known average service life, known historical aftermarket sale prices based on age and condition, and a known scrap value. Accordingly, such parameters can be used to predict the value of other devices of the same make and model. Bearing this in mind, the ItemID may equal a model number as in the case of FIG. 3; however, if a given model includes a plurality of revisions and firmware versions, and if some revisions and/or firmware versions are significantly more valuable than others, e.g. due to quality or feature differences, an item identifier 306 may indicate a set of several indicia such as model 308, revision number 310 and firmware version 312. Therefore, both Eq. 1 and Eq. 2 may be acceptable definitions of the variable ItemID 306 depending on the nature of the item at issue.

$$\begin{matrix}ItemID = Model & ( Eq . 1 ) \\ ItemID = \{ \begin{matrix}Model , \\ Rev . No . , \\ Firmware\end{matrix} \} & ( Eq . 2 )\end{matrix}$$

With continuing regard to the ItemID data type, an ItemID defined according to Eq. 2 may be formulated by a method of the invention rather than being provided in an inventory list. For instance, the seller of an inventory may not know that certain combinations of data (e.g. model, revision number, and firmware number) are meaningful for determining a dollar value. Therefore, it may not be feasible to rely on the seller to make such combinations. Instead, it may be more reliable to specify certain common data fields for a seller to fill in and then rely on a method of the invention to define an ItemID parameter by making appropriate combinations. Furthermore, it is contemplated that ItemID may be defined differently from one product to the next. For instance, it may be sufficient to define an ItemID for one product by simply equating it to a model number, while another product may require model and revision number, and still another may require model, revision, and firmware version numbers. Thus, an embodiment may be suitably programmed to recognize that certain data, e.g. a particular model number, must be combined with certain additional data in order to fully define an ItemID.

In addition to the fields described previously, an historical sales record may include, for instance, fields for recording a buyer's identity 314, a quantity bought 316, and the date of the historical sale 318. If a given historical sale is also a scrap sale then the record may also include a scrap sale field 320. Accordingly, when the data is used for forecasting purposes one may calculate a likely sale price based upon an average of all similar sales, similar sales made to a particular buyer, or similar sales within a certain time range, e.g. a moving average over the last 30 days.

It is contemplated that the data contained in the historical sales database may accumulate over a long period of time. Since some data types may lose their predictive value over time, e.g. price, recording data in association with dates of sale is especially important so that one may treat data accordingly. For instance, a moving average of sale prices may be warranted for estimating a likely current sale price. In cases where a likely current sale price is being predicted, a moving average may include the most recent data and extend back in time to a predetermined limit, e.g. 30 days. Alternatively, in cases where a likely past sale price is being estimated for a sale with an unknown actual sale price, a moving average may include equal time periods before and after the date of the sale to which the estimate relates. Apart from moving averages, other data treatment and/or data correction methods may include, without limitation, adjustments for inflation, foreign currency conversions, cyclic or seasonal price fluctuations, and/or changes in supply and demand pressures.

While a database 300 may include historical sales data, it may also include, without limitation, forecast sales data and scrap sales data. Moreover, forecast sales data may be dynamically linked to historical sales data so that forecasts are automatically updated in real time as new sales are recorded in the database. Similarly, scrap sales data may be dynamically linked to historical scrap sales. Alternatively or additionally, scrap sales data may be dynamically linked to precious metals markets so that scrap value automatically updates in real time as market prices of certain precious metals are received by the system and/or recorded in the database.

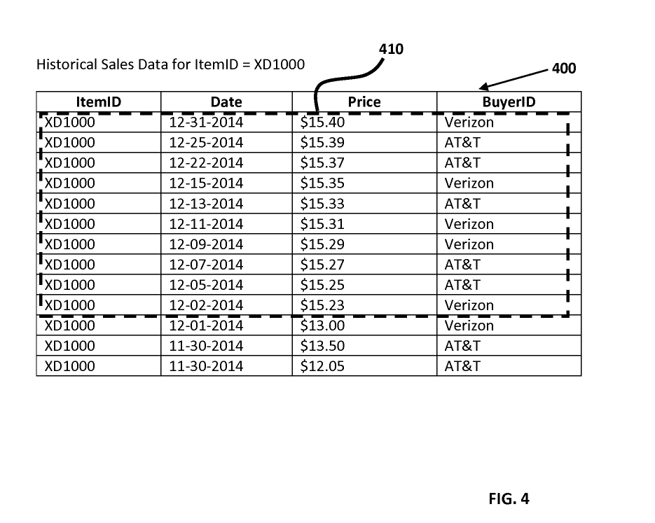

FIG. 4 illustrates an example table of results 400 where the ItemID XD1000 is queried against a historical sales database for similar sales. Box 410 illustrates a thirty day time period from the present, i.e. Dec. 31, 2014 in this case, and extending thirty days backward to Dec. 2, 2014. Thus, box 410 illustrates a data set that may be used to conduct a 30 day moving average calculation such as that shown in Eq. 3 below. Additionally, the data may be used to calculate a 30 day moving average of purchases made by a single buyer, as shown in Eq. 4. The resulting quantity is referred to herein as a historical valuation.

$$\begin{matrix}{〈 Price 〉}_{XD 1000} = \frac{\$153 .19}{10} = \$15 .32 & Eq . 3 \\ {〈 Price 〉}_{XD 1000 , AT \& T} = \frac{\$76 .61}{5} = \$15 .32 & Eq . 4\end{matrix}$$

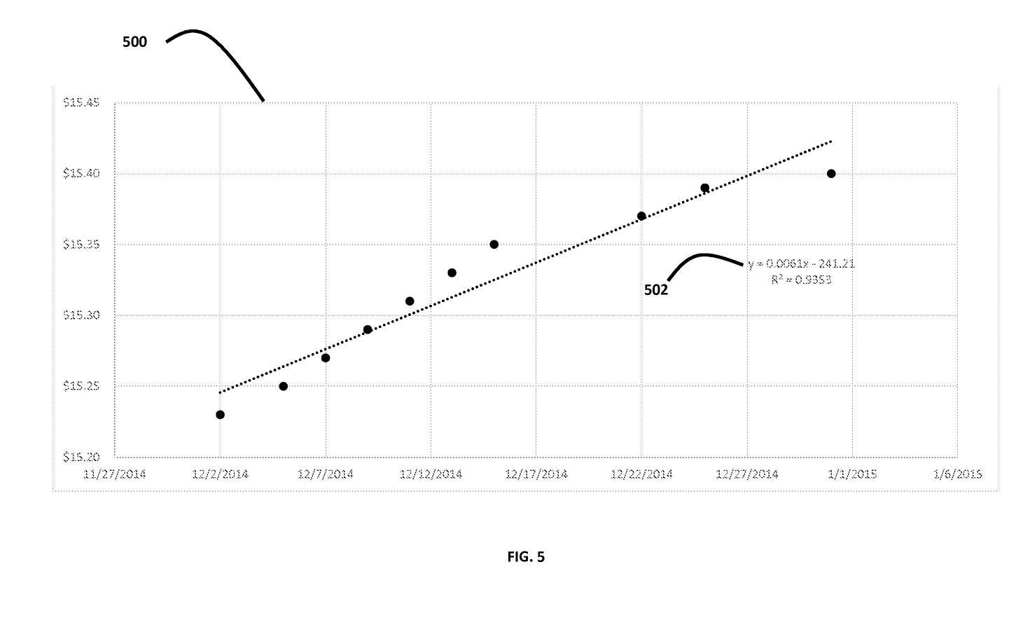

The calculations in Eqs. 3 and 4 presume that only random variation has occurred within the selected time window, i.e. the last 30 days. However, when the data is plotted 500 as shown in FIG. 5, a linear regression analysis reveals that the price is increasing slightly over the selected time period. Accordingly, the historical valuation may be improved in this instance by using a regression method rather than a moving average. Thus, an embodiment of the invention may include a computer programmed to detect random variation versus linear and/or non-linear variation (e.g. quadratic, cubic, etc., or composites or superpositions thereof) in the data and apply a valuation method appropriate to the patterned or random nature of variation in the data.

The linear equation 502 derived from the foregoing regression analysis also enables extrapolation of the data into the near future to predict likely sale price based on historical data. Extrapolation presumes that future data will continue to vary according to historical patterns. In some instances this may be a valid assumption; however, in other instances it may be necessary to account for known present variations in supply and demand and/or projected variations in supply and demand which may not be accounted for in the historical data.

The phrase “known present variations in supply and demand” is intended to denominate changes in the currently known supply of a product, and changes in the currently known demand for a product. Current supply may be reflected by a count of actual inventory available for shipping, while current demand may be measured by a count of currently open orders. Furthermore, as used herein, available inventories may be that of a single broker, or may include inventories of others as reported by them to the broker. Similarly, currently open orders may include orders submitted to the broker for, orders to third parties using a broker's electronic trading system, or orders submitted to third parties and reported to the broker.

In contrast, “projected variations” in supply and demand refer to estimates of future inventory, and estimates of future open orders. Such estimates may be made according to a variety of methods detailed herein. In one example, estimates of future supply may be calculated from historical records using parameters such as, and without limitation, the number of suppliers from whom one normally acquires a given product, and the quantity of product typically available from each supplier over a specified time period. More specifically, if a broker of a given product has two suppliers of the product, and each supplier has an average of five of the product in inventory over any 30 day period, then one may project that a supply of ten will be available over a future 30 day period. According to this example, supply is static; however, projected variations in supply may also be estimated in dynamic cases where the supply of a product is increasing or decreasing, e.g. to meet changing demand. Predictions can be made in dynamic supply cases by applying regression methods to historical supply data.

Similar to the foregoing description of projected variations in supply, variations in demand may also be projected using similar methods. For instance, if the demand for a given product has been constant over a period of time, then one may predict that in the near future the demand will be similar. However, similar to supply, demand may also be dynamic rather than static, so one may apply regression methods to historical demand data to arrive at a prediction of how demand may change over a future period.

According to embodiments of the invention supply and demand parameters may be used to correct current and future price estimates for fluctuations in supply and demand that may not be otherwise accounted for in the historical sales data. For example a supply and demand parameter q may be defined by Eq. 5 where D is demand and S is supply. According to Eq. 5, the probability of selling a given product is 100% whenever q≧1, i.e. whenever demand (D) is greater than or equal to supply (S). As used herein, when q is used as a probability it shall have a maximum value of 1. Conversely, if demand (D) is less than supply (S) then q<1, and the probability of selling a given product is equal to the ratio of D to S.

$$q ≡ \frac{D}{S} \qquad Eq . 5$$

Embodiments may include collecting supply and demand data over long periods of time with respect to particular products represented by particular ItemID's. It may be convenient to break the data into certain intervals such as contiguous 30 day intervals. Thus, in a given interval n a historical supply (S_{n,f}) may be calculated by subtracting depletion due to sales (S_{n,depletion}) from the supply on hand at the beginning of the interval (S_{n,i}) plus any new inventory acquired during the interval (S_{n, new}). Accordingly, in the next interval n+1 the supply (S_{n+1,f}) would be calculated using the final supply of the previous interval as the initial supply of the present interval, i.e. S_{n+1,i}=S_{n,f}. This process may be carried out iteratively for each subsequent time interval to calculate historical supplies for each interval.

S_{n,f}=(S_{n,i}+S_{n,new}−S_{n,depletion}) Eq. 6

S_{n+1,f}=(S_{n+1,i}+S_{n+1,new}−S_{n+1,depletion}); Eq. 7

where S_{n+1,i}=S_{n,f}
Historical demand may be calculated as the sum of all orders received and filled during a given interval. Any unfilled orders are carried over to the next interval so that q does not exceed 1. Accordingly, a historical supply and demand parameter can be written as in Eq. 8.

qₙ=Dₙ/S_{n,f} Eq. 8

Having calculated supply and demand parameters (q) for each historical interval n through m we can calculate the probability of selling any given product during any contiguous subset of intervals n through m. The probability equation would take the form shown in Eq. 9 where the probabilities of not selling a given product during each interval are multiplied, and the resulting quantity is subtracted from one, leaving us with the probability that a given product will be sold during the specified series of intervals.

P_{n,m}=1−(1−qₙ)(1−qₙ₊₁) . . . (1−qₘ) Eq. 9

Embodiments may include analyzing historical probabilities, and/or historical supply and demand data, so derived from historical sales data to discern patterns in supply and demand. For instance, the data may show an annual cyclic pattern corresponding to planned acquisitions of capital equipment tending to occur at, e.g. the end of each quarter. Regardless of the specific pattern or its cause, such patterns may be used to infer a future probability of sales, i.e. a future supply and demand parameter q. This future probability may, according to some embodiments, be used as a scaling factor to adjust the price of the product. For instance, one embodiment may include multiplying a price of a product by a calculated future probability of sale to estimate the future price of the product.

According to some embodiments of the invention, prices may be scaled by a probability q in a variety of ways. In one embodiment, a quantity q may be calculated using current inventory and current demand. Thus, a current price estimated from a 30 day moving average of historical sales data may be multiplied by q to adjust the estimate up or down depending on current supply/demand pressures. In such context it may be advantageous to allow demand D to equal all open orders regardless of whether they are filled in the present interval. Thus, D may be greater than 1, so if demand outpaces supply by a factor of three then the quantity q would be q=3 and the price of the product would triple due to demand. Alternatively, an embodiment may include a step of applying a predefined rule when q attains a certain value, e.g. if q≧1 then multiply the price of the product by scaling factor F. Accordingly, q is not necessarily equal to F, and F may be a constant or a variable, and its value may be determined according to any appropriate rules.

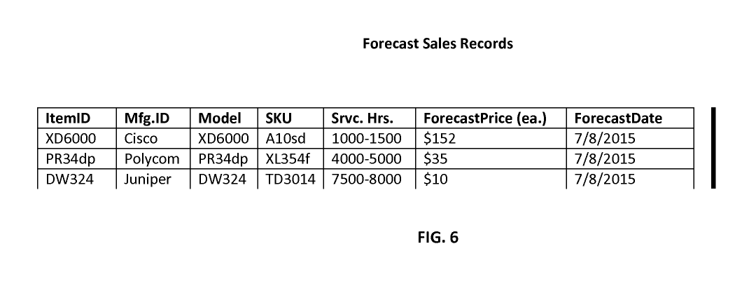

In another embodiment q may be used to scale future prices, for instance, when estimating a future value of a product. In such cases q would be inferred from historical q data provided that a pattern can be discerned from the historical data and confirmed by a regression method(s) to an acceptable degree of confidence. Thus, in this context an estimated future q (pest) obtained through regression would be multiplied by an estimated price (yₑₛₜ) determined by a regression of historical sales data to arrive at an estimated future value (Vₑₛₜ) for a given product. FIG. 6 illustrates a data set showing the forecast sale price of several different items (ItemID). In each instance the forecast price is relevant to the then future date of Jul. 8, 2015.

Vₑₛₜ=(qₑₛₜ)yₑₛₜ Eq. 10

Regarding scrap sales, embodiments may rely on one of several methodologies for determining scrap value. In one embodiment, scrap value may be determined using historical sales data similar to the methodologies described for non-scrap sales. Thus, a historical data set would be compiled over time and moving average and/or regression methods could be used to estimate a current value. In other embodiments scrap value may determined by taking account of the precious metals content of products sharing an ItemID. For example, a sample population of a given product may be ground, weighed, and the entire mass quantitatively transferred and dissolved. A sample of the dissolved product may be appropriately diluted and assayed for its content of particular metals according to known chemical and spectroscopic methods such as atomic absorption or inductively coupled plasma analytical chemical methods. Thus, the precious metals content of a given electronic product can be quantitatively determined to a sufficiently high degree of accuracy to value the product based on its content of these materials.

Metals that may be included in a valuation may include, without limitation, one or more of aluminum, copper, silver, gold, nickel, palladium, platinum, rhodium, iridium, ruthenium, osmium, rhenium, scandium, yttrium, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, plutonium, americium, curium, berkelium, californium, einsteinium, fermium, mendelevium, nobelium, or lawrencium.

In some embodiments, the scrap value of a product may be dynamically linked to the current market value of the foregoing metals as a function of the product's inclusion of such metals which may be read into an embodiment in real time as updated values become available from existing precious metals exchanges and aggregators of price data. Since the mass content of each metal is known for each product, the product may be accurately valued in real time or near real time, by multiplying the mass of its component metals by their present market value.

In still another valuation method of the present invention, the as-is value of a product in need of repair or refurbishment may be calculated. The transaction being valued in this instance is sale of the product as-is from the current owner to an entity that will repair/refurbish and resell the product. According to this method, several factors are taken into account including the likely cost to repair or refurbish products sharing a given ItemID, historical sales data regarding such products in a similar condition, and the going rate for the product in a repaired or refurbished condition. In this method repair costs are tracked for each ItemID. Historical repair data may thus be used to estimate the cost of repairing current or future products having the same ItemID using moving average and/or regression methods as previously described.

The following is intended to illustrate how the foregoing repair/refurbish valuation method may operate in practice. First a product having a given ItemID may be read into an embodiment. The embodiment may then query its historical database to determine the likely cost to repair or refurbish the product based on an average, moving average, and/or regression method applied to the historical data. The embodiment may also query its historical sales database to estimate the value of the item as-is by applying mathematical methods as previously described herein to the historical data. The embodiment may also estimate the resale value of the repaired or refurbished product at a time in the future accounting for the average lead time to repair or refurbish the product. In some embodiments the resale price may be displayed in comparison to the sum of the cost to repair and the as-is valuation.

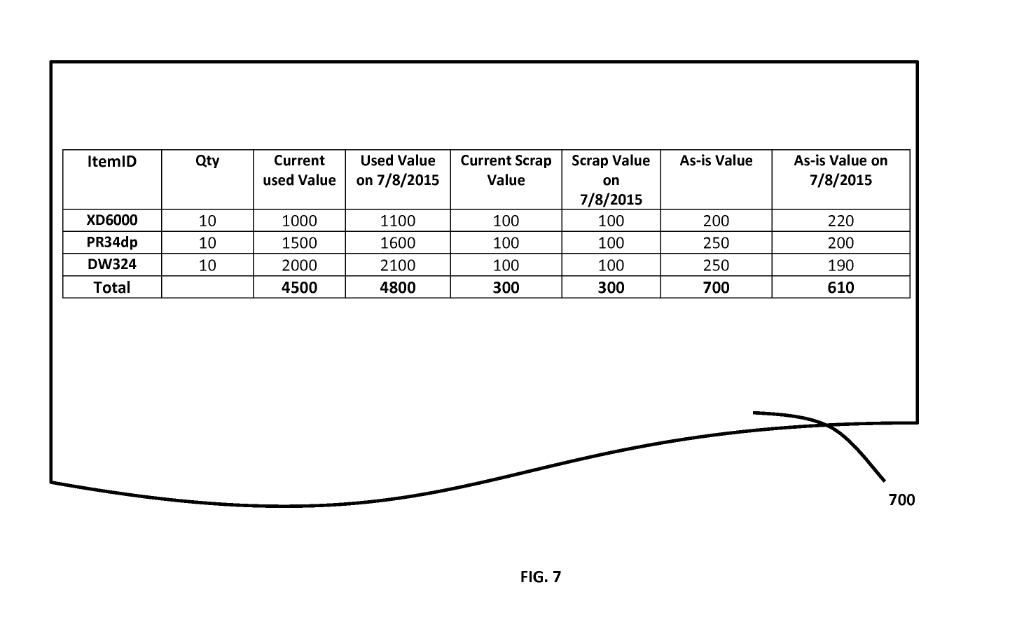

An embodiment may run each of the valuation methods described herein and display the results thereof in a report according to a format convenient for comparing the various valuation estimates. FIG. 7 illustrates such a report 700. The report 700 shows the value of products having three different ItemIDs. Lots of ten of each ItemID are being valued according to six different valuation methods. Current value, current scrap value, current as-is value, and the projected value of each for the future date of Jul. 8, 2015. The report also shows the total value of all thirty products if they were all disposed of according to the same method. As previously described, an alternative report may group products for disposal according to the most advantageous economic return rather than assuming that they will all be disposed of according to the same method.

Methods according to embodiments of the present invention may tend to optimize the efficiency of valuation calculations so as to use minimal computer time and provide faster application response times. For instance, in some embodiments each ItemID is valued only once according to each valuation method regardless of the number of times that an item sharing an ItemID occurs in an inventory list. More specifically, in embodiment 800 valuation of items may entail reading an item from an inventory list 810 and using data associated with the item such as part number, model number, etc. to determine an ItemID 820 for a first item in the list. The embodiment determines whether this ItemID has already been valued 830. If not then historical sales data for corresponding to the ItemID is retrieved from the database and read into memory 840. The embodiment then the embodiment runs a set of valuation calculations as described previously in detail herein and record the results thereof in a lookup table according to ItemID 850. The embodiment may subsequently release the historical data from memory 851, and increments a counter variable 860 corresponding to the ItemID to keep track of the quantity of items in the inventory list sharing this ItemID. At this point the system determines whether the inventory list includes more items 870. If so, then the embodiment loops back through the preceding steps until the list has been fully processed according to this method 800.

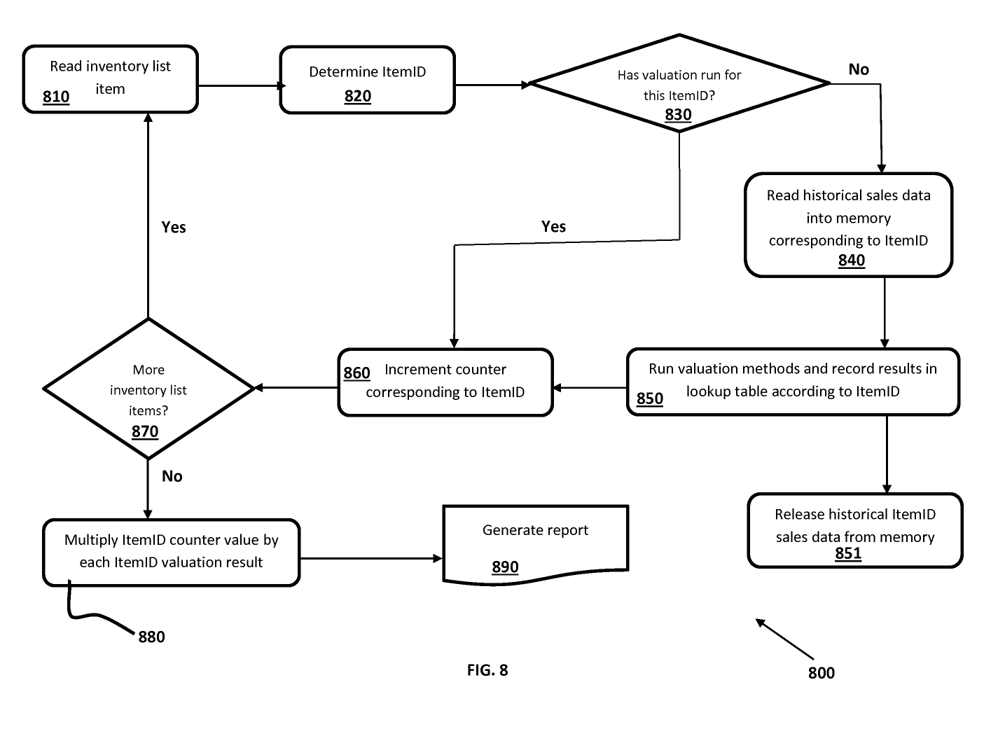

According to the process of FIG. 8, valuation processes according to the invention may be improved by releasing historical data from memory after calculating certain parameters that will be reusable for other items in an inventory list. More particularly, current sale price, scrap sale price, as-is sale price, and forecasts for each on a predetermined date may all be held in memory while releasing the data from which these quantities were calculated. As shown in FIG. 8 the estimated sale prices for a given ItemID may be recorded in a lookup table format 850, and when the embodiment encounters a new item having the same ItemID it may merely increment a counter variable 860 rather than re-running the valuation. After every item on the list has been identified and all non-redundant valuation calculations have been executed, a total value of a given inventory list can be determined by multiplying each valuation of a given ItemID by a corresponding value of the counter variable 880. The multiplication products may then be displayed in a report 890 according to valuation type.

A special class of sales may be referred to herein as premium sales. Premium sales are understood to be sales of products having a value that is enhanced by, without limitation, urgency of a need, the need to stock critical spares, an apparent increase in interest among potential buyers. With respect to urgency, one will appreciate that buyers are often willing to pay more for an item that they need quickly. For instance, if a machine that is necessary for conducting business breaks down or wears out, the owner will reasonably expect to lose business during its downtime. Thus, the faster that the machine can be repaired or replaced the less money that will be lost, and therefore the greater the value of an item that will enable repair or replacement. Similarly, the owner of such equipment may need to maintain a stock of items that would be necessary when the equipment breaks down or wears out. These may be referred to as critical spares.

With respect to apparent increases in interest among potential buyers, such increases may be detected, for instance by tracking search volume of particular items and deeming the most highly searched items to be worth more. One may set the criteria for detecting increased interest in a number of ways, but one method would be to assume that the items accounting for the top 50% (for instance) or more of search volume to be the subject of increased interest and therefore worth more. Alternatively, one may assume the top 100 or 200 searched products may be the subject of increased interest and therefore worth a premium.

In some embodiments the price of a premium product may be determined according to similar predictive techniques described for non-premium products herein, but may additionally include a premium multiplier. The premium multiplier value may be determined empirically through automated analysis of past premium sales, by individual judgment according to perceived demand, or arbitrarily.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

1. A product valuation method comprising the steps of:
providing a database of historical sales including a predetermined set of fields for containing data characterizing historical sales, the set of fields comprising buyer identity, quantity bought, sale price, historical sale date, model number, Common Language Equipment Identification (CLEI) code, SKU number, revision number, firmware version, service hours, and scrap sale;
reading inventory item data fields into memory comprising one or more of a model number, Common Language Equipment Identification (CLEI) code, or a SKU number, and one or more of a revision number, firmware version, or service hours;
selecting one or more inventory table data fields corresponding to an inventory item to be valued and determinative of a monetary value of the inventory item;
equating the selected one or more inventory table data fields to a matrix variable; and
querying the database of historical sales against the matrix variable and reading historical sales data into memory corresponding to the matrix variable;
applying a predetermined set of valuation methods to the historical sales data corresponding to the matrix variable; and
recording the valuation results in a lookup table in association with the corresponding matrix variable.

2. (canceled)

3. (canceled)

4. The method of claim 1, wherein the matrix variable is defined by the set of model number, revision number, firmware version number, and service hours.

5. The method of claim 1, wherein the set of valuation methods comprise a current used value method, a current scrap value method, and a current as-is value method.

6. The method of claim 5, wherein each of the current used value method, current scrap value method, and current as-is value method comprise the steps of:
applying a moving average method to historical used sale price data, scrap sale price data, and as-is sale price data; and
applying a regression method to the historical used sale price data, scrap sale price data, and as-is sale price data, each as a function of a date of sale.

7. The method of claim 6, wherein the results of the moving average method are discarded if the regression method results produce an equation having an R-squared value of at least 90%.

8. The method of claim 1, wherein the set of valuation methods comprise a forecast used value method, a forecast scrap value method, and a forecast as-is value method.

9. The method of claim 8, wherein each of the forecast used value method, forecast scrap value method, and forecast as-is value method comprise the step of applying a regression method to the historical used sale price data, scrap sale price data, and as-is sale price data, each as a function of a date of sale.

10. The method of claim 1, further comprising the step of determining whether a set of valuations have been calculated corresponding to the matrix variable, and if a set of valuations have not been calculated then executing the steps of querying, applying, and recording.

11. The method of claim 10, further comprising the steps of:
incrementing a counter variable corresponding to the matrix variable after executing the step of applying;
repeating each of the foregoing steps on a next inventory item; and
multiplying the value of the counter variable corresponding to the item identifier matrix variable by each of the valuation results corresponding to the same matrix variable value.

12. The method of claim 9, wherein each of the forecast used value methods are calculated using data restricted to historical sales to a predetermined buyer.

13. The method of claim 9, wherein forecast sale price is a function of a current supply versus demand multiplier where the multiplier is greater than one when supply is less than demand, the multiplier is less than one when supply is greater than demand, and the multiplier is one when supply equals demand.

14. The method of claim 13, wherein the current supply versus demand multiplier is a liner function of the number open orders for an item divided by the quantity of the item available to fill orders.

15. The method of claim 1, wherein a scrap sale price is one or more of the most recent scrap sale price, the most recent scrap sale price paid by a particular buyer, or a moving average of scrap sale prices.

16. The method of claim 15, wherein scrap value is directly proportional to a percent content by mass of one or more of aluminum, copper, silver, gold, nickel, palladium, platinum, rhodium, iridium, ruthenium, osmium, rhenium, scandium, yttrium, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, plutonium, americium, curium, berkelium, californium, einsteinium, fermium, mendelevium, nobelium, or lawrencium.

17. The method of claim 16, wherein the scrap value is directly proportional to the market value of one or more of aluminum, copper, silver, gold, nickel, palladium, platinum, rhodium, iridium, ruthenium, osmium, rhenium, scandium, yttrium, lanthanum, cerium, praseodymium, neodymium, samarium, europium, gadolinium, terbium, dysprosium, holmium, erbium, thulium, ytterbium, lutetium, actinium, thorium, protactinium, uranium, neptunium, plutonium, americium, curium, berkelium, californium, einsteinium, fermium, mendelevium, nobelium, or lawrencium.

18. The method of claim 1 further comprising the steps of:
retrieving premium sales data relating to each item of the list from the database according to the matrix variable;
calculating a premium sale value for each item of the list by multiplying a quantity of each item read into memory bearing the same item identifier by a premium sale price for each item having the same item identifier; and
calculating a premium sale total value by summing the premium sale values for each item.

19. The method of claim 18, wherein the premium sale data relate to items that are deemed critical spares, items that are ranked in the top two hundred most searched items, the set of items that collectively account for 50% or more of total product search volume.

20. The method of claim 19, wherein premium sale price is one or more of the most recent historical sale price of any buyer, the most recent historical sale price of a particular buyer, a predicted sale price according to an extrapolation of historical sale prices, or one or more offers to buy at a specified price, wherein the predicted sale price is calculated according to a regression method, wherein the predicted sale price is a function of a current supply versus demand multiplier where the multiplier is greater than one when supply is less than demand, the multiplier is less than one when supply is greater than demand, and the multiplier is one when supply equals demand, and wherein the current supply versus demand multiplier is a liner function of the number open orders for an item divided by the quantity of the item available to fill orders.
